(19) United States
(12) Patent Application Publication
(10) Pub. No.: US 2022/0343917 A1
(43) Pub. Date: Oct. 27, 2022

(54) SCENE-AWARE FAR-FIELD AUTOMATIC SPEECH RECOGNITION

(71) Applicant: University of Maryland, College Park, College Park, MD (US)

(72) Inventors: Zhenyu TANG, Greenbelt, MD (US); Dinesh MANOCHA, Bethesda, MD (US)

(21) Appl. No.: 17/723,339

(22) Filed: Apr. 18, 2022

Related U.S. Application Data
(60) Provisional application No. 63/176,211, filed on Apr. 16, 2021.

(51) Int. Cl. G10L 15/32; G10L 15/06; G10L 15/16

(52) U.S. Cl. CPC G10L 15/32; G10L 15/063; G10L 15/16

(57) ABSTRACT

Methods and systems for far-field speech recognition are disclosed. The methods and systems include receiving multiple noisy speech samples at a target scene; generating multiple labeled vectors and multiple intermediate samples based on the multiple labeled vectors; and determining multiple pair-wise distances between each intermediate sample and each vector of a full set of acoustic impulse responses (AIRs). In some instances, such methods may further include selecting a subset of the full set of AIRs based on the multiple pair-wise distances; and training a deep learning model based on the subset of the full set of AIRs. In other instances, such methods may further include obtaining a deep-learning model trained with a dataset having similar acoustic characteristics to the noisy speech samples; and performing speech recognition of the noisy speech samples based on the trained deep-learning model. Other aspects, embodiments, and features are also claimed and described.

### CROSS-REFERENCE TO RELATED APPLICATION(S)

This application claims priority to U.S. Provisional Application No. 63/176,211, filed on Apr. 16, 2021, which hereby is incorporated herein by reference in its entirety.

### STATEMENT REGARDING FEDERALLY SPONSORED RESEARCH

This invention was made with government support under W911NF1810313 awarded by the Department of the Army, Army Research Office (ARO). The government has certain rights in the invention.

### BACKGROUND

Automatic speech recognition (ASR) is being widely deployed in many real-world scenarios via smartphones and voice assistant devices. A major challenge in ASR is dealing with far-field scenarios, where the speech source is at a significant distance from the microphone. As the demand for ASR continues to increase, research and development continue to advance ASR technologies not only to meet the growing demand for ASR but also to advance and enhance ASR systems used in various environments.

### SUMMARY

The following presents a simplified summary of one or more aspects of the present disclosure, to provide a basic understanding of such aspects. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in a simplified form as a prelude to the more detailed description that is presented later.

In some aspects of the present disclosure, methods, systems, and apparatus for scene-aware far-field automatic speech recognition are disclosed. These methods, systems, and apparatus may include steps or components for receiving multiple speech samples at a target scene; generating multiple labeled vectors corresponding to the multiple speech samples; generating multiple intermediate samples based on the multiple labeled vectors for normalizing noise in the multiple labeled vectors; determining multiple pair-wise distances between each of the multiple intermediate samples and each of multiple vectors of a set of acoustic impulse responses (AIRs); selecting a subset of the set of AIRs based on the multiple pair-wise distances; and training a deep learning model based on the subset of the full set of AIRs.

In other aspects of the present disclosure, methods, systems, and apparatus providing for scene-aware far-field automatic speech recognition are disclosed. These methods, systems, and apparatus implementing the method may include receiving a speech sample; generating a labeled vector corresponding to the speech sample; generating one or more intermediate samples based on the labeled vector for normalizing noise in the labeled vector; determining one or more pair-wise distances between each of the one or more intermediate samples and each of multiple vectors of a full set of acoustic impulse responses (AIRs); training a deep learning model with a dataset of a set of AIRs based on the one or more pair-wise distances; and performing speech recognition of the speech sample based on the determined deep learning model.

In further aspects of the present disclosure, methods, systems, and apparatus providing for scene-aware far-field automatic speech recognition are disclosed. These systems and apparatus implementing the method may include a memory and a processor coupled to the memory. The processor is configured, in coordination with the memory, to receive a speech sample; generate a labeled vector corresponding to the speech sample; generate one or more intermediate samples based on the labeled vector for normalizing noise in the labeled vector; determine one or more pair-wise distances between each of the one or more intermediate samples and each of multiple vectors of a set of acoustic impulse responses (AIRs); determine a deep learning model trained with a dataset of a set of AIRs based on the one or more pair-wise distances; and perform speech recognition of the speech sample based on the determined deep learning model.

These and other aspects of the disclosure will become more fully understood upon a review of the drawings and the detailed description, which follows. Other aspects, features, and embodiments of the present disclosure will become apparent to those skilled in the art, upon reviewing the following description of specific, example embodiments of the present disclosure in conjunction with the accompanying figures. While features of the present disclosure may be discussed relative to certain embodiments and figures below, all embodiments of the present disclosure can include one or more of the advantageous features discussed herein. In other words, while one or more embodiments may be discussed as having certain advantageous features, one or more of such features may also be used in accordance with the various embodiments of the disclosure discussed herein. Similarly, while example embodiments may be discussed below as devices, systems, or methods embodiments it should be understood that such example embodiments can be implemented in various devices, systems, and methods.

### BRIEF DESCRIPTION OF THE DRAWINGS

FIG. 1 is an illustration of an example of a scene-aware acoustic impulse response (AIR) selection process according to some embodiments.

FIG. 2 is a graph showing examples of three datasets for an example target distribution according to some embodiments.

FIG. 3 is a flow diagram illustrating an example process for scene-aware far-field automatic speech recognition according to some embodiments.

FIG. 4 is a flow diagram illustrating an example process for scene-aware far-field automatic speech recognition according to some embodiments.

FIG. 5 is a block diagram illustrating an example scene-aware far-field speech recognition systems in accordance with embodiments of the present disclosure.

FIG. 6 is a block diagram illustrating an example of hardware of an apparatus that performs one or more operations in accordance with the present disclosure.

### DETAILED DESCRIPTION

The detailed description set forth below in connection with the appended drawings is intended as a description of various configurations and is not intended to represent the only configurations in which the subject matter described herein may be practiced. The detailed description includes specific details to provide a thorough understanding of various embodiments of the present disclosure. However, it will be apparent to those skilled in the art that the various features, concepts and embodiments described herein may be implemented and practiced without these specific details. In some instances, well-known structures and components are shown in block diagram form to avoid obscuring such concepts.

Far-field scenarios (e.g., inside rooms, buildings, or other open spaces where audible noise may originate from locations comparatively distant from a speaker—such as farther from a speaker than the listener) can present unique challenges when providing for automated speech recognition. In far-field scenarios, speech audio signals undergo behaviors corresponding to reflections off surfaces or diffraction around obstacles in the environment. These effects distort the speech signal in different ways and thereby require much more training data for a speech recognition algorithm to achieve high accuracy and generalization. However, capturing and transcribing far-field speech data with sufficient acoustic variability is a challenging task due to time and cost constraints. In practice, it may be the case that oftentimes there exists less transcribed far-field training data (e.g., a transcription associated with corresponding audio) available to a developer than data for clean speech (e.g., speech in which background noise and distortions (like reverberation and muffling) is minimal, de minimis, or substantially reduced in comparison to the speech).

In some examples, instead of recording multiple speech utterances in the same room in order to develop training data, one can choose to record the acoustic impulse responses (AIRs) and the non-speech background noise in that room. These recordings can then be reused offline to artificially reverberate clean speech as if it had been recorded in that same environment and generate noisy speech data that can be used as training data for a speech recognition algorithm. When the AIRs and noise are properly recorded, using them to create training data for ASR can produce results as good as using real recorded speech for training.

In recent years, there has been an increasing number of recorded impulse response datasets, thereby improving the performance of far-field ASR. However, each dataset may only involve a limited number of different acoustic environments (e.g., hundreds of AIRs recorded in very few rooms). In addition, different recording devices, recording techniques, and software post-processing have been used across datasets, which can reduce the consistency of recording among these datasets. When creating a training set with a combination of all the AIRs collected from different datasets, domain mismatch due to reverberation/noise level and frequency distortion can occur. In general, training ASR systems using various data is considered beneficial to make the trained model generalize to various test conditions. However, the inclusion of mismatched data for one domain might not improve the performance on that specific domain. Further, training solely with mismatched data can significantly degrade the model performance.

In many scenarios, voice assistant devices (e.g., Apple HomePod®, Amazon Echo®, Google Home™) operate in a given or fixed indoor or room environment whose acoustic characteristics do not change frequently. For this reason, knowing more acoustic characteristics about the target scenario can help select the appropriate training data, as the devices will be used in the same environment. However, in some cases, the detailed information may not be given in advance about the acoustic environment in which the ASR systems will be deployed. Even with many popular far-field ASR benchmarks, the metadata (e.g., room types and dimensions, mic locations, etc.) is missing or not consistently labeled, making it difficult to extract useful acoustic characteristics of the scene.

In some aspects of the present disclosure, systems and methods include generating scene-aware training data that has similar acoustic characteristics as the target scene (i.e., scene-aware) without any a priori knowledge of the ground truth scene characteristics or any metadata of the scene. In further aspects of the disclosure, systems and methods include training one or more deep-learning models based on the scene-aware training data, and/or performing far-field automatic speech recognition using the one or more deep-learning models. In some examples, a deep learning-based estimator may be used to non-intrusively compute the sub-band reverberation time of an environment from its speech samples. Thus, a learning-based method can be used to blindly estimate the scene acoustic features in terms of sub-band reverberation time from unlabeled recorded signals.

In further examples, certain acoustic characteristics of a scene can be modeled using its reverberation time and can be represented using a multivariate Gaussian distribution. The multivariate Gaussian distribution can be fit to the predicted feature distribution and can be used to draw a desired number of AIR samples that have similar reverberation characteristics. This distribution can be used to select acoustic impulse responses from a large real-world dataset for augmenting speech data. The samples can be used to generate a training set which is used to train an ASR model in the same environment. The speech recognition system trained on example scene-aware data consistently outperforms the system trained using many more random acoustic impulse responses. The benefit of the disclosed systems and methods are shown by extensively comparing it to alternative data strategies on two public far-field ASR benchmarks: the REVERB challenge and the AMI corpus. The disclosed systems and methods can utilize a subset that is only 5% of the available real-world AIRs for training while consistently outperforming results obtained by using the full set of AIRs. The disclosed systems and methods also outperform uniformly selected subsets of the same size by up to 2.64% word error rate.

In some examples, some scenarios can be considered where clean speech is artificially reverberated using AIRs and recorded noise to create far-field training data. In some instances, real-world AIRs or simulated ones can be used. And, the noise recordings may include non-speech recordings of actual noise at the target location (e.g., machine noise such as HVAC, ambient traffic noise, pet noise, or the like), or may include pre-recorded noises from other locations/environments that are determined to be related to actual noise at the target location. When a set of AIRs and noise recordings is available, the set of AIRs and noise recordings can be mixed using the formulation expressed by:

xᵣ[t]=x[t]*h[t]+d[t], Equation 1

where * denotes a linear convolution, x[t] represents the clean speech signal, h[t] is the AIR corresponding to the speech source, d[t] represents ambient noise, and xᵣ[t] represents the augmented far-field speech that is used for training. Obtaining a large number of x[t] and d[t] can be relatively easy. However, capturing h[t] from the real world is laborious work. Over the past decades, multiple research groups have collected more usable AIR datasets, as listed in Table 1.

Although the full set of AIRs may have more diverse reverberation characteristics than any individual dataset, they might not match the characteristics of any target scene. For example, if the ASR device is to be deployed in a very reverberant room, there may be many samples in the full AIR dataset that are not quite reverberant that will not help with ASR applications in these scenarios, and it may be better to train a model with matched data. Thus, the full available set of AIRs for training may not be optimal. Therefore, instead of training a huge model with all the AIR augmented data and hoping it can generalize well to all scenes, a few unlabeled speech samples can be analyzed from the target scene, and then a matched set of AIRs can be selected to augment data for this scene. Alternatively, many ASR models that specialize in different scenarios can be pre-trained, and the scene analysis can be directly used to select a model already trained on matched data to load.

TABLE 1
Real-world AIR datasets (3316 AIRs in total). Some
contain data other than AIRs (e.g., speech, noise, etc.).

| Name | Number of AIRs, | |
|---|---|---|
| environments | channels, and recording | Year |
| BUT Reverb | 1300+ mono channel AIRs recorded | 2019 |
| Database | in 8 rooms. | |
| MIT IR Survey | 271 mono channel AIRs all recorded | 2016 |
| | in distinct places. | |
| ACE Challenge | {1, 2, 3, 5, 8, 32} channel AIRs | 2015 |
| | recorded in 7 rooms. | |
| Multichannel | 234 8-channel AIRs recorded in the same | 2014 |
| Impulse Response | room with 3 levels of reverberation and | |
| Database | different microphone array spacings | |
| REVERB | 24 8-channel AIRs recorded in small, | 2013 |
| Challenge | medium, and large rooms. | |
| OpenAIR | Ambisonic B format AIRs recorded in | 2010 |
| | over 46 (still increasing) environments. | |
| C4DM AIR | 468 mono or ambisonic B format AIRs | 2010 |
| database | recorded in 3 large environments. | |
| Aachen impulse | 344 binaural AIRs measured with a | 2009 |
| response | dummy head in 5 environments. | |
| RWCP Sound | 143 multi-channel AIRs recorded in | 2000 |
| Scene | 14 rooms. | |

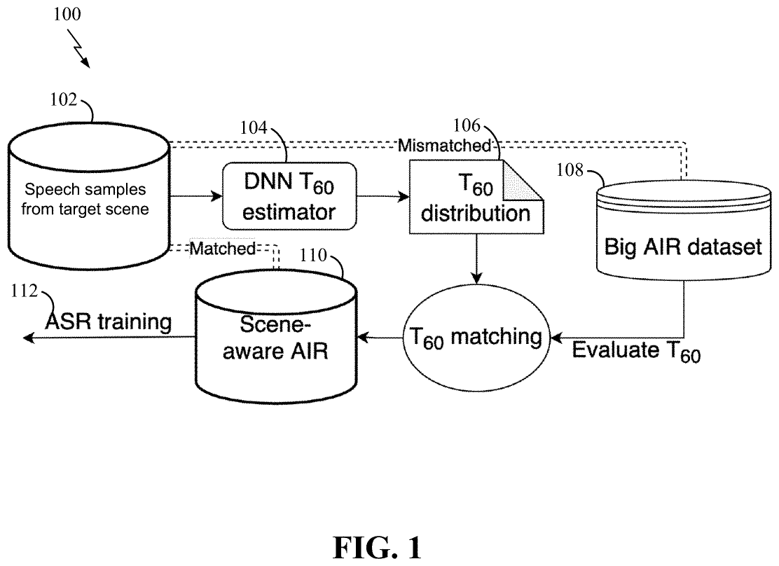

The general outline of this process 100 is summarized in FIG. 1. For example, an apparatus can receive some speech samples 102 from the target scene, a DNN-based T60 estimator 104 can infer the received speech samples' distribution (e.g., T₆₀ distribution) 106 which can be modeled as a multivariate normal distribution. Then, scene-aware AIRs 110 (e.g., a subset of the full set of AIRs) can be selected from the big AIR dataset 108 collected from the real-world according to the target distribution, which can be used for ASR training 112.

Many acoustic features can be used to describe the acoustic properties of an environment. The AIR fully represents the sound propagation behavior in an environment and is of crucial interest during scene analysis. Some standard acoustic metrics including reverberation time (T₆₀), direct-to-reverberant ratio (DRR), early decay time (EDT), clarity (C₈₀), definition (D₅₀), etc., are useful scalar descriptors that can be calculated from an AIR. In an example scene-aware framework, some of these metrics can be blindly estimated from raw speech signals because the exact AIR may not be available corresponding to the test conditions. One example acoustic metric is T₆₀. T₆₀ can be defined as the time it takes for the initial impulse energy to decay by 60 dB, either for full-band or sub-band. However, it should be appreciated that any other acoustic metrics can be used in the example scene-aware framework. In the example scene-aware framework, sub-band T60 can be predicted to capture the frequency dependency of real-world AIRs.

A deep-neural network (DNN) can be used in the example scene-aware framework. In one example, a DNN can include six 2D convolutional layers followed by a fully connected layer. In some examples, the DNN can receive a 4-second speech spectrogram as input, and output multiple sub-band metrics (e.g., 7 sub-band T60s) centered at various frequencies (e.g., 125, 250, 500, 1000, 2000, 4000, and 8000Hz). In some examples, the training of this estimator is based on synthetic AIRs generated and tested on unseen real-world AIRs from a real-world AIR dataset (e.g., the MIT IR Survey which has diverse T60s). The synthetic AIRs can be used because the synthetic AIRs are enough to get T60 estimates with trackable error. Thus, the real-world AIRs can be reserved for testing and a 0.23s mean test error is obtained despite the synthetic vs. real-world domain mismatch. In other examples, real-world AIRs could be used for training the analysis network instead of synthetic AIRs.

In some examples, publicly available AIRs can be collected, as listed in Table 1. Because they come in different audio formats, all AIRs can be converted to single-channel forms (e.g., at a 16 kHz sample rate). In the example experiments, 3316 real-world AIRs are retained in total. This serves as a full set of AIRs for experiments. Then, the sub-band T₆₀s (e.g., a vector of length 7) of each AIR can be evaluated. In some scenarios, the T₆₀ vectors of the full AIR set can be denoted as {sᵢ}_{i-1 . . . K}, Sᵢ ∈ [symbol] ⁷, where K=3316. With the sub-band T₆₀ labels, a subset of them can be selected to match with any desired distribution.

For example, N unlabeled noisy speech samples exist from the target scene and M (M<K) real-world AIRs are selected to match this scene (M can be independent of N). The T₆₀ estimator described above can be used to create T₆₀ labels for N unlabeled noisy speech samples, which yields N sub-band T₆₀ vectors {tᵢ}_{i-1 . . . N}, tᵢ ∈ [symbol] ⁷. While multiple measurements in the same room have some noise and the T₆₀ may not be identical, N sub-band T₆₀ vectors resemble a Gaussian distribution. Therefore, the column-wise mean vector μ and the covariance matrix Σ of the N×7 T₆₀ prediction matrix can be calculated by stacking {tᵢ} vertically. The column-wise mean vector μ and the covariance matrix Σ of the N×7 T₆₀ prediction matrix can be used to draw M intermediate samples {\hat{t}ᵢ}_{i-1 . . . M} following the multivariate Gaussian distribution (μ, Σ). Finally, the pair-wise distance (e.g., pair-wise Euclidean distance) between all M intermediate samples {\hat{t}ᵢ} and all the T₆₀ vectors of the full AIR set {sᵢ}, forming a distance matrix D ∈ [symbol] ^{M×K}, where Di,j=dist (\hat{t}ᵢ, sᵢ). In some examples, the scene matching problem can be:

argminₖ_{_{j∈{1 . . . K}}}Σᵢ₌₁^{M}D_{i,k j}, subjec to: ∀≠j,kᵢ≠kⱼ, Equation 2

where {sₖ_{ᵢ}}_{i-1 . . . , M} corresponds to the M selected samples that minimize the total distance. This can be an assignment problem, and the Kuhn-Munkres algorithm can be used to efficiently select M samples from the full AIR set. The selected M samples can represent acoustic characteristics of the target scene more accurately than the full AIR set.

Various types of DNN algorithms can be utilized in accordance with the concepts described herein: both for creating a T₆₀ estimator and for use as an ASR that utilizes augmented training data to learn to recognize speech.

In some instances, an ASR may be based on a deep-learning model. A deep-learning model can be effectively trained with the selected M samples for the target scene or scenes having similar acoustic characteristics to the target scene. In some embodiments, a deep-learning model can include an input layer, one or more hidden layers (or nodes), and an output layer. In some instances, the input layer may include as many nodes as inputs provided to the deep-learning model. The number (and the type) of inputs provided to the deep-learning model may vary (e.g., based on the types of scenes, the types of acoustic characteristics, the number of scenes to be recognized, the number of channels of audio recording, the frequency spectrum of a recording, sub-bands of the recording, etc.).

The input layer connects to one or more hidden layers. The number of hidden layers varies and may depend on the particular task for the deep-learning model. Additionally, each hidden layer may have a different number of nodes and may be connected to the next layer differently. For example, each node of the input layer may be connected to each node of the first hidden layer. The connection between each node of the input layer and each node of the first hidden layer may be assigned a weight parameter. Additionally, each node of the deep-learning model may also be assigned a bias value. In some configurations, each node of the first hidden layer may not be connected to each node of the second hidden layer. That is, there may be some nodes of the first hidden layer that are not connected to all of the nodes of the second hidden layer. The connections between the nodes of the first hidden layers and the second hidden layers are each assigned different weight parameters. Each node of the hidden layer is generally associated with an activation function. The activation function defines how the hidden layer is to process the input received from the input layer or from a previous input or hidden layer.

Each hidden layer may perform a different function. For example, some hidden layers can be convolutional hidden layers which can, in some instances, reduce the dimensionality of the inputs. Other hidden layers can perform statistical functions such as max pooling, which may reduce a group of inputs to the maximum value; an averaging layer; batch normalization; and other such functions. In some of the hidden layers each node is connected to each node of the next hidden layer, which may be referred to then as dense layers. Some deep-learning models including more than, for example, three hidden layers may be considered deep neural networks.

The last hidden layer in some embodiments of an ASR deep-learning model can be connected to the output layer. Similar to the input layer, the output layer typically has the same number of nodes as the possible outputs. In an example in which the deep-learning model, the output layer may output recognized speech.

Different types of training processes can be used for DNNs. The training processes may include, for example, gradient descent, Newton's method, conjugate gradient, quasi-Newton, Levenberg-Marquardt, among others.

The deep-learning model can be constructed or otherwise trained associated with a target scene based on selected M samples using one or more different learning techniques, such as supervised learning, unsupervised learning, reinforcement learning, ensemble learning, active learning, transfer learning, or other suitable learning techniques for neural networks. As an example, supervised learning involves presenting a computer system with example inputs and their actual outputs (e.g., categorizations). In these instances, the deep-learning model is configured to learn a general rule or model that maps the inputs to the outputs based on the provided example input-output pairs.

Different types of deep-learning models can have different network architectures (e.g., number of layers, type of layers, ordering of layers, connections between layers, hyperparameters for layers). In some configurations, deep-learning models can be structured as a single-layer perceptron network, in which a single layer of output nodes is used and inputs are fed directly to the outputs by a series of weights. In other configurations, deep-learning models can be structured as multilayer perceptron networks, in which the inputs are fed to one or more hidden layers before connecting to the output layer.

As one example, a deep-learning model can be configured as a feedforward network, in which the connections between nodes do not form any loops in the network. As another example, an deep-learning model can be configured as a recurrent neural network (“RNN”), in which connections between nodes are configured to allow for previous outputs to be used as inputs while having one or more hidden states, which in some instances may be referred to as a memory of the RNN. RNNs are advantageous for processing time-series or sequential data. Examples of RNNs include long-short term memory (“LSTM”) networks, networks based on or using gated recurrent units (“GRUs”), or the like.

Deep-learning models can be structured with different connections between layers. In some instances, the layers are fully connected, in which each all of the inputs in one layer are connected to each of the outputs of the previous layer. Additionally or alternatively, deep-learning models can be structured with trimmed connectivity between some or all layers, such as by using skip connections, dropouts, or the like. In skip connections, the output from one layer jumps forward two or more layers in addition to, or in lieu of, being input to the next layer in the network. An example class of neural networks that implement skip connections are residual neural networks, such as ResNet. In a dropout layer, nodes are randomly dropped out (e.g., by not passing their output on to the next layer) according to a predetermined dropout rate. In some embodiments, a deep-learning model can be configured as a convolutional neural network (“CNN”), in which the network architecture includes one or more convolutional layers. Thus, based on the trained deep-learning model based on the selected AIR samples of the full set of AIRs associated with a target scene, effective far-field speech recognition can be performed.

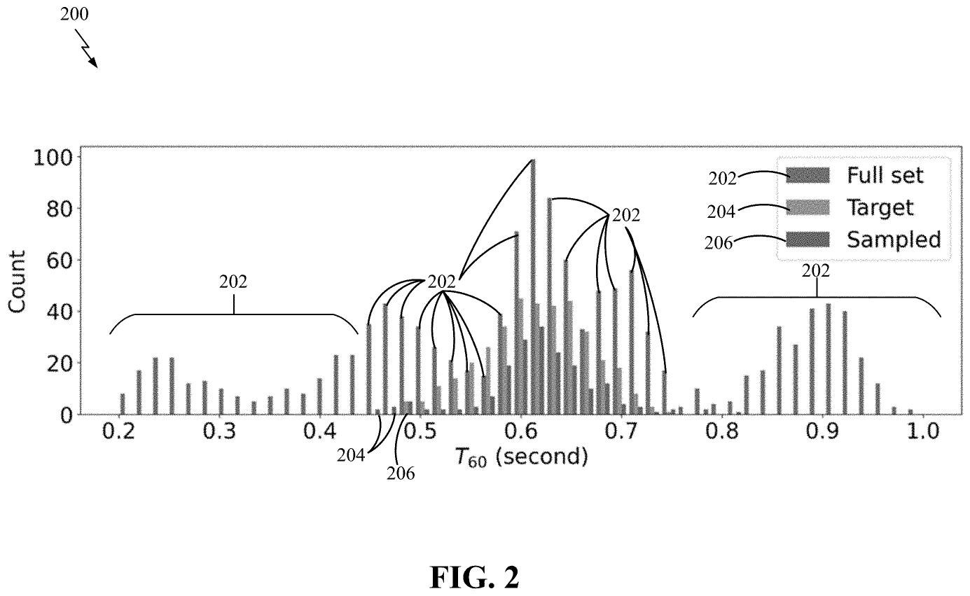

An example of the matching outcome is depicted in FIG. 2. T₆₀ of the full AIR set (3316 AIRs) in Table 1 (202, capped at 1.0s), predicted target scene T₆₀ distribution 204, and T₆₀ of the re-sampled subset of AIRs (206) according to the target distribution. For example, the graph shows multiple sets of Thos. Each set of the multiple sets includes three different T₆₀s: a first set 202 on the left indicative of the full set, a second set 204 in the middle indicative of target scene T₆₀ distribution, and a third set 206 on the right indicative of T₆₀ of the re-sampled subset of AIRs. T₆₀ for the 500 Hz sub-band is plotted and the results are similar for other sub-bands. The number of AIRs in the re-sampled subset is 166, but can be set to any number below the size of the full AIR set. In some examples, the T₆₀ labels may not be very accurate for the entire scene, and some margin for errors can be allowed. So, the empirical mean average prediction error of the T₆₀ estimator can be added to the diagonal entries of the covariance matrix Σ before drawing the intermediate samples. The added mean average prediction error of the T₆₀ estimator can generate a slightly wider T₆₀ distribution than the original fit. In addition, this idea can be extended to any custom distribution sampling (e.g., uniform distribution).

To test the effectiveness of the example scene-aware ASR approach, experiments with two far-field ASR benchmarks were conducted, and the word error rate (WER) resulting from different AIR selection strategies is reported. In the experiments, the example scene-aware AIRs are compared with two alternative strategies for speech augmentation purposes: 1. use all available AIRs (i.e., the full set); 2. select a subset of AIRs with a uniform T₆₀ distribution. The same set of additive noise recorded in the BUT Reverb Database was used during augmentation for all experiments. Both experiments were performed with the Kaldi ASR toolbox 1 using a time delay neural network (TDNN). Other examples of neural networks may also be utilized, such as other convolutional neural networks or other ASR algorithms that require labeled/transcribed training data. In this example, each TDNN was trained on a workstation with two GeForce® RTX 2080 Ti graphic cards.

The AMI corpus includes 100 hours of meeting recordings. The recordings include close-talking speech recorded by individual headset microphones (IHM) and far-field speech recorded by single distant microphones (SDM). While the IHM data is not of anechoic quality, it still has a very high signal-to-noise ratio compared with the SDM data, so it can be considered clean speech. The original Kaldi recipe treats IHM and SDM partitions as separate tasks (i.e., both training and test sets are from the same partition), so a modified pipeline is used, the IHM data using Equation (1) is reverberated as the training set, and the trained model was tested on SDM data.

In the experiments, scene matching was performed using the example method described above targeting the SDM data. In total, 166 real-world AIRs (5% of the full set) have been selected for augmentation of the IHM data. Further, because many IHM recordings have very long durations with pauses between utterances, per-segment level speech reverberation was also performed. To do so, each recording is scanned and, whenever a continuous 3 seconds of a non-speech segment was detected, the recording was split at the beginning of the silent frames to prevent inter-segment speech from overlapping after adding reverberation. Each segment was randomly assigned with an AIR from the AIR pool (either full set, uniform set, or scene-aware set) for convolution. The original 687 IHM recordings were split into 17749 segments, which enabled better utilization of the AIRs for augmentation.

Test results are shown in Table 2. The results are also provided for the clean IHM training set not using any AIR, whose WER is the worst, indicating it is difficult to expect good results from severely mismatched scenes (i.e., IHM vs SDM). Overall, the results show that using the full set of AIRs is not optimal. On the SDM test data, using a uniform subset of AIRs achieves 1.2% (absolute) lower WER than the full set. In addition, the example scene-aware subset achieves 1.9% (absolute) lower WER than the full set, making the example scene-aware subset the best augmentation set.

TABLE 2
WER [%] for the AMI corpus. Training sets are based
on reverberated IHM data except the clean
IHM set, which is also not tested on the
reverberated IHM (hence “—”). Even though the scene-
aware subset is only 5% of thefull set (with 3316
AIRs), lower WER was obtained in comparison
to using the full set or the same-sized uniform subset.

| | IHM (rvb) | | SDM | |
|---|---|---|---|---|
| AIR used | dev | Eval | dev | eval |
| None (clean IHM) | — | — | 54.1 | 63.5 |
| Full set | 39.2 | 44 | 44.6 | 47.7 |
| Uniform | 35.6 | 40.6 | 43.6 | 46.5 |
| Scene-aware | 27.9 | 30.9 | 42.7 | 45.8 |

The REVERB challenge is based on the WSJCA0corpus, which contains 140 speakers each speaking approximately 110 utterances. In this challenge, 3 rooms of different sizes are used to create artificial reverberation data (simulated rooms) by convolving their AIRs with the clean WSJCAM0 speech. Another large room is used to record re-transmitted WSJCAM0 speech (real room). Microphones are placed at two distances (near and far) from the speaker in both simulated and real rooms. Note that the full set contains the original AIRs from the REVERB challenge as they are sourced in Table 1, and to avoid leaking any “ground truth” AIRs into training, these AIRs were excluded from the full set during this experiment. From the reduced full AIR set, 166 AIRs were selected to match the real room scene, and 166 AIRs were mixed with 7861 clean utterances from REVERB for training. The test was performed on simulated room 3, which have similar T₆₀ to the real room.

The results are presented in Table 3 below. For the real room results, using the full set outperforms using a uniform subset. However, the example scene-aware subset still consistently performs the best on both near and far microphone tests. Compared to the same-sized uniform subset, the example scene-aware subset achieves up to a 2.64% (absolute) improvement in WER. Even though the training set is intentionally matched to simulated room 3, the scene-aware subset still achieves the best far microphone results and the second-best near mic results.

TABLE 3
WER[%] for the REVERB challenge. Original uses the original
AIRs provided by the challenge, which partially match the condition
in each room except the real room. Full set (—) means excluding
Original from Full set. The example scene-aware subset (5% of the
full set) achieves the best results in the target real room.

| | Simulated room 3 | | | | Real room | | | |
|---|---|---|---|---|---|---|---|---|
| | near mic | | far mic | | near mic | | far mic | |
| AIR used | dev | eval | dev | eval | dev | eval | dev | eval |
| Original | 4.23 | 4.75 | 6.67 | 7.40 | 18.65 | 17.90 | 20.90 | 20.51 |
| Full set (—) | 6.03 | 6.73 | 7.86 | 9.01 | 15.85 | 17.21 | 15.93 | 17.45 |
| Uniform | 5.24 | 6.24 | 8.08 | 9.19 | 17.59 | 18.84 | 18.25 | 19.01 |
| Scene-aware | 4.62 | 5.25 | 6.65 | 7.33 | 13.79 | 16.38 | 14.83 | 16.37 |

In the present disclosure, a DNN-based sub-band T60 estimator is used to non-intrusively analyze speech samples from a target environment and fit a multivariate Gaussian distribution to represent T60 distribution effectively. The fitted distribution is used to guide the selection of real-world AIRs, which can generate scene-aware training data for the target environment. With both the REVERB challenge and the AMI corpus, the example scene-aware AIR always results in the ASR model with the lowest word error rate.

### Flow Diagram

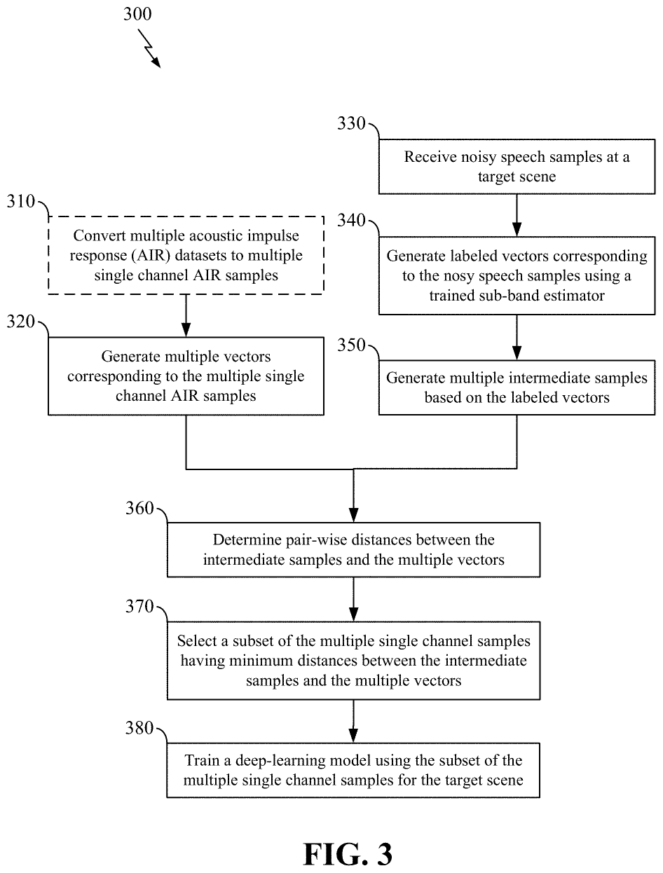

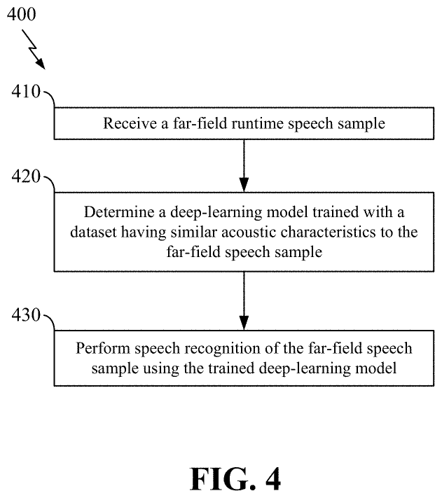

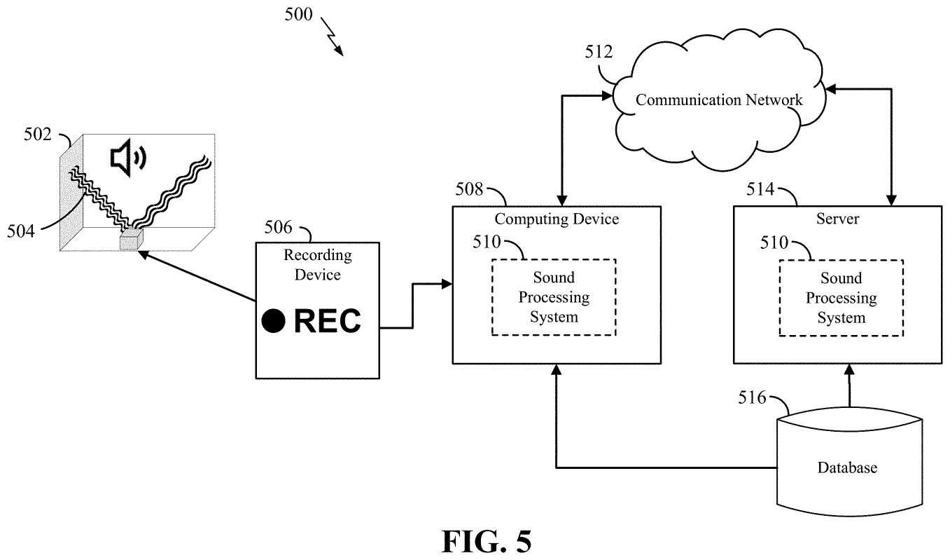

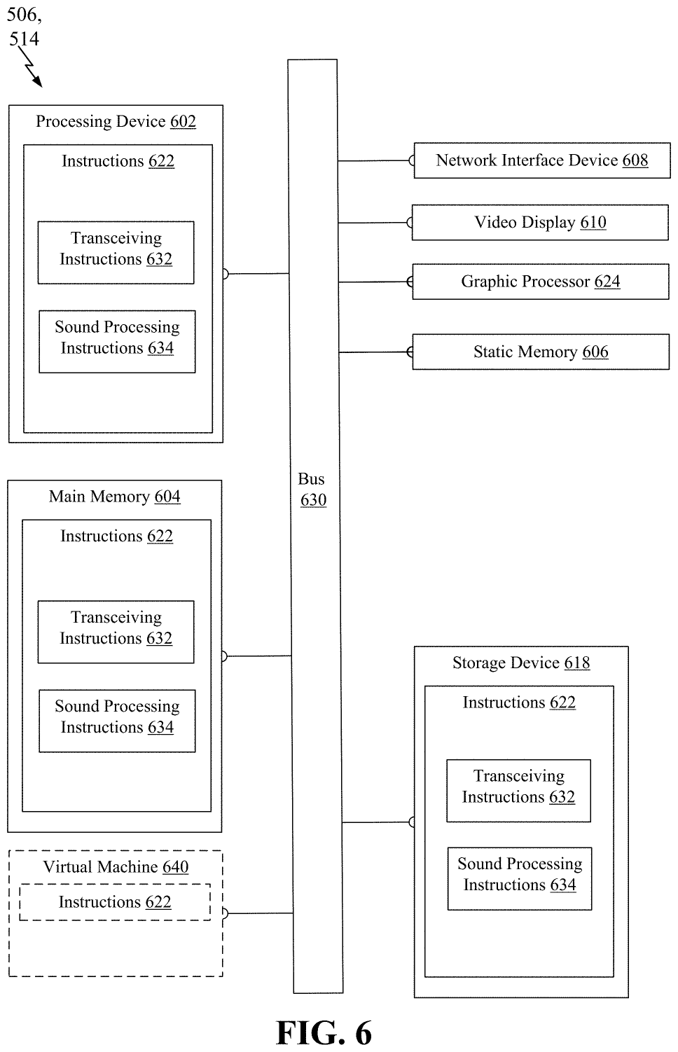

FIG. 3 is a flow diagram illustrating an example process 300 for scene-aware far-field speech recognition in accordance with some aspects of the present disclosure. As described below, a particular implementation can omit some or all illustrated features and may not require some illustrated features to implement all embodiments. In some examples, an apparatus (e.g., recording device 506, server 514) in connection with FIGS. 5 and 6 can be used to perform the example process 300. However, it should be appreciated that any suitable apparatus or means for carrying out the operations or features described below may perform the process 300. Process 300 is generally directed to a pre-training stage to train a deep-learning model. In other embodiments, a part of process 300 can be used to determine a trained deep learning model in a runtime stage. The determination of a trained deep learning model is further described in connection with FIG. 4.

At block 310, the apparatus can convert multiple acoustic impulse response (AIR) datasets to multiple single-channel AIR samples. For example, multiple research groups collected usable AIRs. The multiple AIR datasets from multiple research groups can have diverse reverberation characteristics at diverse scenes, which can increase the accuracy of speech recognition in different scenes. However, the multiple AIR datasets can be produced/distributed in different audio formats. Thus, the apparatus can convert the multiple AIR datasets into a single channel format. For example, the converted multiple single-channel AIR samples can be generated at a 16 kHz sample rate. However, it should be appreciated that the sample rate for the single-channel AIR samples can be any other suitable sample rate. The multiple single-channel AIR samples are described as a set of AIRs or the full set of AIRs above. In some examples, the apparatus may use a single AIR dataset rather than multiple AIR datasets with different audio formats. In other examples, the apparatus may exploit multiple AIR datasets with a single sample rate. Then, the apparatus may not or does not need to perform the conversion process of block 310, and block 310 can be optional.

In some examples, using the full set of possible/available AIRs to train a deep-learning model for far-field speech recognition might not be optimal due to different scenes having different reverberation characteristics. For example, AIR samples that are not reverberant might not be very effective for training a deep-learning model to recognize speech in a very reverberant room. Thus, blocks 320-370 generally elaborate on how to select a scene-specific subset of the full AIR dataset for training.

At block 320, the apparatus may generate multiple vectors corresponding to the multiple single-channel AIR samples or the full set of AIRs. For example, the apparatus can generate a vector to represent the acoustic characteristics of each AIR of the full set of AIRs. The vectors (e.g., T₆₀ vectors) for the full set of AIRs can directly be evaluated from IRs using non-deep-learning methods by its definition. For example, the multiple vectors corresponding to the full set of AIRs can include reverberation time (T₆₀) vectors. In some examples, T₆₀ can be defined as the time it takes for the initial impulse energy to decay by 60 dB, either for full-band or sub-band. However, it should be appreciated that the vector is not limited to a T₆₀ vector to represent the acoustic characteristics of a scene. For example, the vector may be indicative of reverberation time (T₆₀), direct-to-reverberant ratio (DRR), early decay time (EDT), clarity (C₈₀), definition (D₅₀), or any other suitable acoustic metrics to represent acoustic characteristics of the corresponding scene.

In some examples, once the apparatus generates the multiple vectors corresponding to the full set of AIRs, the apparatus does not need to regenerate the multiple vectors again because the full set of base AIRS does not change. Thus, the apparatus may reuse the multiple vectors corresponding to the full set of AIRs to train multiple deep-learning models. When the additional set of AIRs is added to the full set of AIRs, the apparatus can generate additional vectors corresponding to the additional set and add the additional vectors to the multiple vectors for a bigger base AIR dataset.

At block 330, the apparatus can receive noisy speech samples at a target scene. In some examples, the noisy speech samples are not labeled by a sub-band estimator. In some examples, the apparatus may perform block 330 separate from block 320 or after performing block 320. In various examples, such speech samples are recorded and received with both knowledge and consent of individuals, in accordance with all applicable laws, and securely to ensure the privacy of individuals, to protect confidential information and other sensitive subject matter, etc.

At block 340, the apparatus can generate multiple labeled vectors corresponding to the noisy speech samples using a trained sub-band estimator. For example, the apparatus will blindly estimate some metrics (e.g., T₆₀, DRR, EDT, C₈₀, D₅₀, etc.) from the noisy speech samples at the target scene using the trained sub-band estimator. In some examples, the sub-band estimator can create T₆₀ labels for the noisy speech samples and generate multiple sub-band T₆₀ vectors with T₆₀ labels corresponding to the multiple speech samples. In some examples, the sub-band estimator can predict sub-band T₆₀ to capture the frequency dependency of real-world AIRs. In anon-limiting example, the sub-band estimator can receive unlabeled noisy speech samples as input, and outputs labeled T₆₀ vectors. Each vector can include multiple sub-band T₆₀s centered at multiple frequencies (e.g., 7 sub-band T₆₀s centered at 25, 250, 500, 1000, 2000, 4000, and 8000 Hz).

The apparatus or another apparatus may train the sub-band estimator based on synthetic AIRs. However, it should be appreciated that the estimator may be trained with real-world AIRs. Thus, the multiple labeled vectors can represent acoustic characteristics at the target scene rather than at mixed scenes in the full set of AIRs. In some examples, the sub-band estimator can include six 2D convolutional layers followed by a fully connected layer. Then, the apparatus may select a subset of the full set of AIRs to match with any desired distribution through blocks 350-370.

At block 350, the apparatus can generate multiple intermediate samples based on the multiple labeled vectors. For example, the apparatus can generate multiple intermediate samples because the multiple labeled vectors may not be identical due to some noise. In some examples, the apparatus can calculate the column-wise mean vector μ and the covariance matrix Σ of the N (the number of multiple labeled vectors)×7 T₆₀ prediction matrix) by stacking the labeled vectors vertically. The matrix can be written as [v₁; v₂; . . . ; v_{N}], where v, is the ith predicted T60 vector. Then, multiple intermediate samples can be generated based on the multiple labeled vectors. For example, an intermediate sample (\hat{t}ᵢ) can be directly sampled from a known Gaussian distribution N (μ, Σ) using a random number generator. In some examples, the number of multiple intermediate samples can be the same as or different from the number of multiple labeled vectors. In further examples, the number of multiple intermediate samples can be the same as the number of the subset of the full set of AIRs to train a deep-learning model for the target scene.

At block 360, the apparatus can determine pair-wise distances between the intermediate samples and the multiple vectors. Here, the multiple vectors may correspond to the multiple single-channel AIR samples. In some examples, M intermediate samples can be expressed as: {\hat{t}ᵢ}_{i=1, . . . , M} and the K vectors corresponding to the full set of AIRs can be expressed as: {sᵢ}_{i=1, . . . , K}. Then, the apparatus can calculate and determine the pair-wise distance (e.g., Euclidean distance) between all intermediate samples {\hat{t}ᵢ} and the multiple vectors {sᵢ}, which can be expressed as a distance matrix D_{i,j}=dist (\hat{t}ᵢ, sⱼ) ∈ [symbol] ^{M×K}. Thus, the apparatus can determine a M×K distance matrix based on the distance between each intermediate sample and each vector.

At block 370, the apparatus can select a subset of multiple single-channel samples or the full set of AIRs having the minimum distances between the intermediate samples and the multiple vectors. For example, the apparatus may select M vectors among the K multiple vectors corresponding to the M intermediate samples. In some examples, the number of intermediate samples could be 5% of the full set of AIRs. However, it should be appreciated that the number of intermediate samples could be 1%, 2%, 10%, 20%, or any other suitable number of the subset of the full set of AIRs. The apparatus can select a vector among the multiple vectors where the vector minimizes the Euclidean distance between an intermediate sample and each vector of the multiple vectors. The apparatus can repeat this process for each intermediate sample. Thus, the apparatus can select M vectors among multiple vectors for each sample of the M intermediate samples. This can be expressed as:

argminₖ_{ⱼ}_{∈{1 . . . K}}Σᵢ₌₁^{M}D_{i,k j}, subjec to: ∀i≠j,kᵢ≠kⱼ,

where K refers to the number of the full set of AIRs, M indicates the number of the multiple intermediate samples, and D_{i,k}_{ⱼ} indicates a distance between intermediate sample i and each vector j of the multiple vectors corresponding to the full set of AIRs. Thus, the apparatus can determine a vector for each intermediate sample, where the vector has the minimum distance between the corresponding intermediate sample and each of the multiple vectors.

In other examples, the apparatus can determine vectors for corresponding intermediate samples to minimize the overall distance. For example, a distance matrix can be expressed as D_{i,j}=dist (\hat{t}ᵢ, sⱼ) ∈ [symbol] ^{M×K}, where \hat{t}ᵢ is an intermediate vector at label i, and sⱼ is a vector of the multiple vectors corresponding to the full set of AIRs at label j. The apparatus can determine a label j for each intermediate vector i to minimize the overall distance. Thus, the sum of the distance between each intermediate vector (M vectors) and a vector of the multiple vectors (K vectors) corresponding to the full set of AIRs is a smaller overall distance in comparison to the other overall distance.

In some examples, labels js for intermediate vectors is do not overlap. Since the selected label directly corresponds to a single-channel sample of the full set of AIRs, the apparatus can select a subset of multiple single-channel samples or the full set of AIRs corresponding to selected M vectors. In some examples, the selected subset of the full set of AIRs may be AIRs in similar scenes to the target scene and may have similar acoustic characteristics to those in the target scene.

At block 380, the apparatus can train a deep-learning model using the subset of the multiple single-channel AIR samples for the target scene. In addition, the apparatus can exploit the noisy speech samples to train the deep-learning model. Thus, the apparatus can train the deep-learning model with augmented speech data.

In some embodiments, the apparatus can repeatedly perform blocks 330-380 for different target scenes. Thus, the apparatus can train multiple deep-learning models with different sets of AIRs for corresponding target scenes. For example, if multiple rooms exist, some rooms may be reverberant while other rooms are not, and each room can have a different level of acoustic characteristics. As such, multiple deep-learning models corresponding to the multiple rooms can be trained with different subsets of the full set of AIRs. In other examples, some rooms having similar acoustic characteristics can be grouped together and used to train a deep-learning model for the rooms.

FIG. 4 is a flow diagram illustrating an example process 400 for scene-aware far-field speech recognition in accordance with some aspects of the present disclosure. As described below, a particular implementation can omit some or all illustrated features and may not require some illustrated features to implement all embodiments. In some examples, any suitable apparatus or means for carrying out the operations or features described below may perform the process 400. Process 400 is generally directed to a run-time stage to determine a trained deep-learning model and perform scene-aware far-field speech recognition using the trained deep-learning model.

At block 410, an apparatus receives a far-field runtime speech sample. In some examples, the apparatus may not receive one or more pieces of information (or any information) describing or otherwise indicating attributes of a scene of the far-field runtime speech sample. In various examples, such speech samples are recorded and received with both knowledge and consent of individuals, in accordance with all applicable laws, and securely to ensure the privacy of individuals, to protect confidential information and other sensitive subject matter, etc.

At block 420, the apparatus can determine a deep-learning model trained with a dataset having similar acoustic characteristics to the far-field runtime speech sample. In the example process 300 in connection with FIG. 3, an apparatus can use different subsets of single-channel AIR samples to train deep-learning models for different corresponding scenes. Thus, each trained deep-learning model can provide improved speech recognition performance at a specific scene or a scene having similar reverberation characteristics to the specific scene.

In some examples, to determine a scene-aware deep-learning model, the apparatus can generate a labeled vector corresponding to the far-field runtime speech sample using a trained sub-band estimator as elaborated at block 340 in connection with FIG. 3. In further examples, the apparatus can generate one or more intermediate samples to normalize noise in the target scene as illustrated at block 350 in connection with FIG. 3. In addition, the apparatus can determine pair-wise distances between the one or more intermediate samples and the multiple vectors corresponding to the full set of AIRs as illustrated at block 360 in connection with FIG. 3. The apparatus can determine labels in the full set of AIRs based on the minimum pair-wise distances as illustrated at block 370 in connection with FIG. 3. Based on the selected or determined subset of the full set of AIRs, the apparatus can identify a deep-learning model trained with a dataset similar to the selected subset of the full set of AIRs.

In some examples, the dataset to train the deep-learning can have the same labels in the full set of AIRs as the labels of the selected subset of the full set of AIRs for the far-field runtime speech sample. In other examples, the apparatus can select a trained deep-learning model when the dataset to train the deep-learning model shares a predetermined number of AIRs with the selected subset of the full set of AIRs. In further examples, each AIR with a label can have a different weight to train a deep-learning model at a specific scene. Thus, the apparatus can select a trained deep-learning model when the difference between the weighted sum of the AIR dataset to train the deep-learning model and the weighted sum of the selected subset of the full set of AIRs corresponding to the far-field runtime speech sample is less than a predetermined threshold. However, it should be appreciated that the selection of a deep-learning model based on the training dataset is not limited to the examples described above.

At block 430, once the apparatus develops (constructs, trains, etc.) the scene-aware deep-learning model, the apparatus can perform speech recognition of the far-field runtime speech sample using the trained deep-learning model.

In some aspects of the disclosure, the apparatus can train multiple deep-learning models based on scene-specific subsets of the full set of AIRs as described in connection with FIG. 3. Then, the same or different apparatus can receive a scene-unaware far-field speech. The apparatus can find a dataset in the full set of AIRs similar to the scene-unaware far-field speech. The apparatus can identify a scene-aware deep-learning model trained with a subset of the full set of AIRs similar to the dataset corresponding to the scene-unaware far-field speech. The apparatus can perform speech recognition of the scene-unaware far-field speech based on the scene-aware deep-learning model. However, this is one example. It should be appreciated that the apparatus can perform any other suitable training and run-time far-field speech recognition based on the disclosed systems and methods.

### Example System Configuration

FIG. 5 is a block diagram illustrating an example scene-aware far-field speech recognition system 500 in accordance with embodiments of the present disclosure. A recording device 506 can receive a far-field noisy speech signal 504 in a target scene 502. In some examples, the recording device 506 can store the far-field speech signal 504 and perform sampling of the far-field noisy speech signal 504. For example, the recording device 506 can store portions or samples of the far-field speech signal in a non-transitory computer-readable medium as a digital file. Then, the recording device 506 can transmit the noisy speech samples at the target scene 502. In various examples, such recording is performed with both knowledge and consent of individuals, in accordance with all applicable laws, and securely to ensure the privacy of individuals, to protect confidential information and other sensitive subject matter, etc.

In some embodiments, a computing device 508 can receive the noisy speech samples at the target scene 502. In some embodiments, the computing device 508 can execute at least a portion of a sound processing system 510 to perform a sound processing task, such as generating labeled vectors corresponding to the noisy speech samples, generating multiple intermediate samples based on the labeled vectors, determining par-wise distance between the intermediate samples and the multiple vectors, selecting a subset of the multiple single-channel samples having minimum distances between the intermediate samples and the multiple vectors, training a deep-learning model using the subset of the multiple single-channel samples for the target scene, determining a deep-learning model trained with a dataset having similar acoustic characteristics to the far-field speech sample, and/or performing speech recognition of the far-field speech sample.

In some examples, the computing device 508 may include one or more neural networks (e.g., sub-band estimator to generate labeled vectors, and/or deep-learning models to perform speech recognition). In some examples, the computing device 508 or the sound processing system 510 can transmit noisy speech samples to a server 514 via a communication network 512. In other examples, the computing device or the sound processing system 510 can process generating the multiple intermediate samples of the noisy speech samples and transmit the multiple intermediate samples to the server 514 via the communication network 512. Then, the server 514 may include at least a portion of the sound processing system 510 to perform any one or more of the operations or features, such as generating labeled vectors corresponding to the noisy speech samples, generating multiple intermediate samples based on the labeled vectors, determining par-wise distance between the intermediate samples and the multiple vectors, selecting a subset of the multiple single-channel samples having minimum distances between the intermediate samples and the multiple vectors, training a deep-learning model using the subset of the multiple single-channel samples for the target scene, determining a deep-learning model trained with a dataset having similar acoustic characteristics to the far-field speech sample, and/or performing speech recognition of the far-field speech sample.

In addition, the server 514 may return information to the computing device 508 (and/or other suitable computing device) indicative of an output of a sound processing task performed by the sound processing system 510. However, the trained deep-learning models or sub-band estimator are not limited to being in the computing device 508 or the server 514. For example, the trained deep-learning models or sub-band estimator may be in a separate apparatus (e.g., a separate server, a cloud server, etc.). The sound processing system 510 may execute any or all of the one or more portions of processes 300 and 400.

In some examples, the computing device 508 and/or the server 514 can obtain the full set of AIRs in a database 516. In some instances, the full set of AIRs can be single-channel AIRs. For example, the computing device 508 or the server 514 can receive multiple AIR datasets from other databases and convert the multiple AIRs from the multiple AIR datasets to multiple single-channel AIR samples. Further, the computing device 508 and/or the server 514 can generate multiple vectors corresponding to the multiple single-channel AIR samples and store the multiple vectors and/or the multiple single-channel AIR samples (e.g., the full set of AIRs) in the database 516.

In some embodiments, the communication network 512 can be any suitable communication network or combination of communication networks. For example, the communication network 512 can include a Wi-Fi® network (which can include one or more wireless routers, one or more switches, etc.), a peer-to-peer network (e.g., a Bluetooth network), a cellular network (e.g., a 3G network, a 4G network, a 5G network, etc., complying with any suitable standard, such as CDMA, GSM, LTE™, LTE Advanced, NR, etc.), a wired network, etc. In some embodiments, the communication network 512 can be a local area network, a wide area network, a public network (e.g., the Internet), a private or semi-private network (e.g., a corporate or university intranet), any other suitable type of network, or any suitable combination of networks. Communications links shown in FIG. 5 can each be any suitable communications link or combination of communications links, such as wired links, fiber optic links, Wi-Fi® links, Bluetooth® links, cellular links, etc.

In some embodiments, the computing device 508 and/or the server 514 can be any suitable computing device or combination of devices, such as a desktop computer, a laptop computer, a smartphone, a tablet computer, a wearable computer, a server computer, a computing device integrated into a vehicle (e.g., an autonomous vehicle), a camera, a robot, a virtual machine being executed by a physical computing device, etc.

### Hardware Configuration Example

FIG. 6 is a block diagram illustrating an example of hardware of an apparatus (e.g., computing device 508 and/or server 514) within which a set of instructions, for causing the apparatus to perform any one or more of the methods disclosed herein, may be executed. In alternative implementations, the apparatus may be connected (such as networked) to other apparatus in a LAN, an intranet, an extranet, and/or the Internet.

The apparatus may operate in the capacity of a server or a client machine in a client-server network environment, as a peer machine in a peer-to-peer (or distributed) network environment, or as a server or a client machine in a cloud computing infrastructure or environment. The apparatus may be a server computer, a personal computer (PC), a tablet PC, a set-top box (STB), a Personal Digital Assistant (PDA), a cellular telephone, a web appliance, a server, a network router, a switch or bridge, or any apparatus capable of executing a set of instructions (sequential or otherwise) that specify actions to be taken by that apparatus. Further, while a single apparatus is illustrated, the term “apparatus” shall also be taken to include any collection of apparatuses that individually or jointly execute a set (or multiple sets) of instructions to perform any one or more of the methods discussed herein.

The example apparatus (e.g., computing device 508, server 514) includes a processing device 602, a main memory 604 (such as read-only memory (ROM), flash memory, dynamic random access memory (DRAM) such as synchronous DRAM (SDRAM) or DRAM, etc.), a static memory 606 (such as flash memory, static random access memory (SRAM), etc.), and a storage device 618, which communicate with each other via a bus 630.

Processing device 602 represents one or more general-purpose processing devices such as a microprocessor, a central processing unit, or the like. More particularly, the processing device 602 may be complex instruction set computing (CISC) microprocessor, reduced instruction set computing (RISC) microprocessor, very long instruction word (VLIW) microprocessor, or processor implementing other instruction sets, or processors implementing a combination of instruction sets. Processing device 602 may also be one or more special-purpose processing devices such as an application specific integrated circuit (ASIC), a field programmable gate array (FPGA), a digital signal processor (DSP), network processor, and the like. The processing device 602 is configured to execute instructions 622 for performing the operations and steps discussed herein.

The apparatus 600 may further include a network interface device 608 for connecting to the LAN, intranet, internet, and/or the extranet. The apparatus 600 also may include a video display unit 610 (such as a liquid crystal display (LCD) or a cathode ray tube (CRT)), and one or more graphic processor 624 (such as a graphics card).

The storage device 618 (e.g., data storage device) may be a machine-readable storage medium (also known as a computer-readable medium) on which is stored one or more sets of instructions 622 (e.g., software or any type of machine-readable instructions) embodying any one or more of the operations or methods described herein. The instructions 622 may also reside, completely or at least partially, within the main memory 604 and/or within the processing device 602 during execution thereof by the computer system 600, the main memory 604 and the processing device 602 also constituting machine-readable storage media.

In an example, the instructions 622 may include transceiving instructions for receiving noisy speech samples at block 330 of FIG. 3 and/or at block 410 of FIG. 4. The instructions 622 may further include sound processing instructions 634 for converting multiple AIR datasets to multiple single-channel AIR samples, generating multiple vectors corresponding to the multiple single-channel AIR samples, generating labeled vectors corresponding to the noisy speech samples, generating multiple intermediate samples based on the labeled vectors, determining par-wise distance between the intermediate samples and the multiple vectors, selecting a subset of the multiple single-channel samples having minimum distances between the intermediate samples and the multiple vectors, training a deep-learning model using the subset of the multiple single-channel samples for the target scene, determining a deep-learning model trained with a dataset having similar acoustic characteristics to the far-field speech sample, and/or performing speech recognition of the far-field speech sample at blocks 310, 320, 340, 350, 360, 370, and/or 380 of FIG. 3 and/or at blocks 420 and/or 430 of FIG. 4.

While the storage device 618 is shown in an example implementation to be a single medium, the term “machine-readable storage medium” should be taken to include a single medium or multiple media (such as a centralized or distributed database, and/or associated caches and servers) that store the one or more sets of instructions. The term “machine-readable storage medium” shall also be taken to include any medium that is capable of storing or encoding a set of instructions for execution by the machine that cause the machine to perform any one or more of the operations or features of the present disclosure. The term “machine-readable storage medium” shall accordingly be taken to include, but not be limited to, solid-state memories, optical media and magnetic media. The term “machine-readable storage medium” shall accordingly exclude transitory storage mediums such as signals unless otherwise specified by identifying the machine-readable storage medium as a transitory storage medium or transitory machine-readable storage medium.

In another implementation, a virtual machine 640 may include a module for executing instructions such as transceiving instructions 632, and/or sound processing instructions 634. In computing, a virtual machine (VM) is an emulation of a computer system. Virtual machines are based on computer architectures and provide functionality of a physical computer. Their implementations may involve specialized hardware, software, or a combination of hardware and software.

Some portions of the preceding detailed descriptions have been presented in terms of algorithms and symbolic representations of operations on data bits within a computer memory. Such descriptions and representations (e.g., pre-training a deep-learning model based on a subset of AIRs, determining a trained deep-learning model, and/or performing scene-aware speech recognition) are the ways used by those skilled in the art effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “modifying” or “providing” or “calculating” or “determining” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage devices. The present disclosure also relates to an apparatus for performing the operations herein. This apparatus may be specially constructed for the intended purposes, or it may comprise a computing device or other machine (e.g., a specialized or special purpose machine) selectively activated or reconfigured by a computer program stored in the computer. Such a computer program may be stored in a computer-readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The examples presented herein are not inherently related to any particular computer or other apparatus. Various types of systems may be used with programs in accordance with the teachings herein, or it may prove convenient to construct a more specialized apparatus to perform the method. The structure for a variety of these systems will appear as set forth in the description below. In addition, the present disclosure is not described with reference to any particular programming language or form of machine-readable or machine-executable instructions. It will be appreciated that a variety of programming languages may be used to implement the teachings of the disclosure as described herein. Further, machine-readable and machine-executable instructions may exist and be used in various forms including source code, executable code, interpretable code such as an intermediate language, code writing in a scripting language, etc.

The present disclosure may be provided as a computer program product, or software, that may include a machine-readable medium having stored thereon instructions, which may be used to program a computer system (or other electronic devices) to perform operations in accordance with the present disclosure. A machine-readable medium generally may include any mechanism for storing information in a form readable by a machine (such as a computer). For example, a machine-readable (such as computer-readable) medium includes a machine (such as a computer) readable storage medium such as a read-only memory (“ROM”), random access memory (“RAM”), magnetic disk storage media, optical storage media, flash memory devices, etc.

In the foregoing specification, implementations of the disclosure have been described with reference to specific example implementations thereof. It will be evident that various modifications may be made thereto without departing from the broader spirit and scope of implementations of the disclosure as set forth in the following claims. The specification and drawings are, accordingly, to be regarded in an illustrative sense rather than a restrictive sense.

What is claimed is:

1. A method for providing far-field speech recognition, comprising:
receiving multiple speech samples associated with a target scene;
generating multiple labeled vectors corresponding to the multiple speech samples;
generating multiple intermediate samples based on the multiple labeled vectors for normalizing noise in the multiple labeled vectors;
determining multiple pair-wise distances between each of the multiple intermediate samples and each of multiple vectors of a set of acoustic impulse responses (AIRs);
selecting a subset of the set of AIRs based on the multiple pair-wise distances; and
training a deep learning model based on the subset of the set of AIRs.

2. The method of claim 1, wherein a labeled vector of the multiple labeled vectors includes a reverberation time (T₆₀) vector.

3. The method of claim 1, wherein generating multiple labeled vectors corresponding to the multiple speech samples is based, at least in part, on a sub-band estimator.

4. The method of claim 3, wherein the sub-band estimator receives the multiple speech samples,
wherein the sub-band estimator outputs the multiple labeled vectors, and
wherein a labeled vector from the sub-band estimator includes multiple sub-band reverberation times centered at multiple frequencies.

5. The method of claim 3, wherein the sub-band estimator comprises at least six 2D convolutional layers followed by a fully connected layer.

6. The method of claim 1, wherein a pair-wise distance of the multiple pair-wise distances is a Euclidean distance.

7. The method of claim 1, wherein the selecting the subset of the set of AIRs comprises:
for each intermediate sample of the multiple intermediate samples, identifying a distance between a respective intermediate sample and each of the multiple vectors of the set of AIRs;
identifying multiple labels of a subset of labeled vectors having a minimum overall distance for the multiple intermediate samples; and
selecting the subset of the set of AIRs based on the multiple labels of the subset of labeled vectors.

8. The method of claim 7, wherein the minimum overall distance is a minimized sum of distances of each intermediate sample between the respective intermediate sample and each of the multiple vectors of the set of AIRs.

9. A method for far-field speech recognition, comprising:
receiving a speech sample;
generating a labeled vector corresponding to the speech sample;
generating one or more intermediate samples based on the labeled vector for normalizing noise in the labeled vector;
determining one or more pair-wise distances between each of the one or more intermediate samples and each of multiple vectors of a set of acoustic impulse responses (AIRs);
training a deep learning model with a dataset of a set of AIRs based on the one or more pair-wise distances; and
performing speech recognition of the speech sample based on the determined deep learning model.

10. The method of claim 9, wherein the determining the deep learning model comprises:
for each intermediate sample of the one or more intermediate samples, identifying a distance between a respective intermediate sample and each of the multiple vectors of the set of AIRs; and
identifying one or more labels of a subset of labeled vectors having a minimum overall distance for the one or more intermediate samples,
wherein the identified one or more labels share more than a predetermined number of labels of the dataset associated with training of the deep learning model.

11. The method of claim 10, wherein the minimum overall distance is a minimized sum of distances of each intermediate sample between the respective intermediate sample and each of the multiple vectors of the set of AIRs.

12. The method of claim 9, wherein the labeled vector includes a reverberation time (T₆₀) vector.

13. The method of claim 9, wherein the generating the labeled vector corresponding to the speech sample is based, at least in part, on a sub-band estimator.

14. The method of claim 13, wherein the sub-band estimator receives the speech sample,
wherein the sub-band estimator outputs the labeled vector, and
wherein the labeled vector from the sub-band estimator includes multiple sub-band reverberation times centered at multiple frequencies.

15. The method of claim 13, wherein the sub-band estimator comprises at least six 2D convolutional layers followed by a fully connected layer.

16. The method of claim 9, wherein a pair-wise distance of the one or more pair-wise distances is a Euclidean distance.

17. A system for far-field speech recognition, comprising:
a memory; and
a processor coupled to the memory,
wherein the processor is configured, in coordination with the memory, to:
receive a speech sample;
generate a labeled vector corresponding to the speech sample;
generate one or more intermediate samples based on the labeled vector for normalizing noise in the labeled vector;
determine one or more pair-wise distances between each of the one or more intermediate samples and each of multiple vectors of a set of acoustic impulse responses (AIRs);
determine a deep learning model trained with a dataset of a set of AIRs based on the one or more pair-wise distances; and
perform speech recognition of the speech sample based on the determined deep learning model.

18. The system of claim 17, to determine a deep learning model trained with a dataset of a set of AIRs, the processor is further configured to:
for each intermediate sample of the one or more intermediate samples, identifying a distance between a respective intermediate sample and each of the multiple vectors of the set of AIRs; and
identifying one or more labels of a subset of labeled vectors having a minimum overall distance for the one or more intermediate samples,
wherein the identified one or more labels share more than a predetermined number of labels of the dataset associated with training of the deep learning model.

19. The system of claim 18, wherein the minimum overall distance is a minimized sum of distances of each intermediate sample between the respective intermediate sample and each of the multiple vectors of the set of AIRs.

20. The system of claim 17, wherein the labeled vector includes a reverberation time (T₆₀) vector.
